(19) United States
(12) Patent Application Publication
(10) Pub. No.: US 2024/0144394 A1
(43) Pub. Date: May 2, 2024

(54) METHOD IMPLEMENTED BY A DISPLAY SYSTEM FOR HOSTING DIGITAL CONTENT TEAM DISPLAY CONTESTS AND QUANTIFYING SOCIAL MEDIA POPULARITY

(71) Applicant: GAMANIA DIGITAL ENTERTAINMENT CO., LTD., Taipei City (TW)

(72) Inventors: Kuan Yu CHEN, Taipei City (TW); You Lin YAO, Taipei City (TW)

(21) Appl. No.: 18/465,534

(22) Filed: Sep. 12, 2023

(30) Foreign Application Priority Data
Nov. 1, 2022 (TW) 111141666

(51) Int. Cl. G06Q 50/00; G06Q 10/101; G06Q 30/0201

(52) U.S. Cl. CPC G06Q 50/01; G06Q 10/101; G06Q 30/0201

(57) ABSTRACT

A Method implemented by a display system for hosting digital content team display contests and quantifying social media popularity, is implemented through a display system. The system consists of a display server and a user big data server. The method involves multiple users participating in a display team, where the display server showcases the digital content contributed by these users as showpiece. Furthermore, the display server displays the showpiece and/or the display team in a display theme and records the social media interaction behavior data of the showpiece and/or the display team, which is then transmitted to the user big data server. The user big data server calculates the social media interaction behavior data of the showpiece and/or the team based on the quality differences in social media interaction behaviors and stores them separately in a database. Users can increase the popularity and value of their created digital content by participating in the display team.

### CROSS-REFERENCE TO RELATED APPLICATIONS

This non-provisional application claims priority under 35 U.S.C. § 119 on Patent Application No. TW111141666 filed in Taiwan, Republic of China Nov. 1, 2022, the entire contents of which are hereby incorporated by reference in its entirety.

### FIELD OF THE INVENTION

The invention pertains to the domain of digital content, specifically a team-based mechanism and technology for collaborative displays that utilizes social media interactions to boost the popularity of the displayed content. Additionally, the invention provides a means for quantifying the social media popularity of digital content displays.

### BACKGROUND OF INVENTION

With the proliferation and advancement of Internet technology, anyone can create and publish digital content on online platforms. The value or popularity of such digital is conventionally gauged through simple summation metrics such as the count of likes and comments from users on social media platforms. However, these methods are quite susceptible to manipulation, such as artificially inflating likes or comments. Another approach is the utilization of subjective human evaluations to judge the popularity of user responses. This method, while providing some insight, inherently carries a high degree of subjectivity and fails to offer a quantifiable metric.

For creators or holders of digital content, there lacks a effective method to accurately gauge the popularity of their digital works on online platforms or to discern the types of content that resonate most with the audience. Moreover, existing digital content display platforms often rely on individual creators to publish, where accumulating engagement largely depends on their personal prominence. This poses a significant challenge for newcomers who need to quickly gain recognition for their digital creations. To address this pressing issue, the present invention introduces an objective method for quantifying the social media popularity of digital content through a team-based mechanism. This approach harnesses the collective power of teams to amplify the exposure of individual's digital content and enhance its popularity.

### SUMMARY OF THE INVENTION

The present invention proposes a method for method implemented by a display system for hosting digital content team display contests and quantifying social media popularity. This method combines joint display team techniques with algorithmic analysis of big data databases to measure the social media popularity value of digital content.

The present invention provides a method for a method implemented by a display system for hosting digital content team display contests and quantifying social media popularity, which is implemented by a display system 10 that is applicable to a user device 20 capable of logging into the display system 10 with a user accounts. The display system 10 comprises a display server 100 and a user big data server 200. The method involves the following Steps: a display server 100 receives a request from a user device 20 to an add a new showpiece or choose a request to select an existing showpiece. In case of the add a new showpiece, the display server 100 permits the user device 20 to upload or import a digital content as multiple showpieces, associates the digital content with a user account, and stores it in a database. If it is a request to select the request to select an existing showpiece. The display server 100 retrieves the relevant the digital content associated with the user account stored in the database and provides the user device 20 with the option to choose one as the showpiece. The display server 100 receives a team participation request from the user device 20 to participate in a display team through a team planning/selection interface. In response to the team participation request, the display server 100 stores information about the showpiece participating in the display team in the database, provides a display interface that shows the showpiece and the display team, and records a social media interaction behavior data of the showpiece and the display team separately through the display interface. The display server 100 then sends the social media interaction behavior data to a user big data server 200. The user big data server 200 receives the social media interaction behavior data, determines a social media popularity of the showpiece and the display team based on the differences in quality of different social media engagement behaviors, and sends the social media popularity data to the display server 100; and the display server 100 receives the social media popularity data, and stores the social media popularity of the showpiece and the display team separately in the database.

The method of importing the digital content involves importing from various the digital content websites' URLs and importing from encrypted cryptocurrency wallets.

The method of the present invention further includes, the display server 100 providing a showpiece editing interface to the user device 20, which allows the user to input a showpiece description. The display server 100 then stores the showpiece description in the database, and displays it on the showpiece of the display interface.

The display server 100 receiving an team planning request from the user device 20 through the team planning/selection interface, and providing an team construction interface in response to the team planning request. Using the team construction interface, the display server 100 then receives a team information and a team publishing request from the user device 20, stores the team information in the database, and displays it on the display interface of the display team.

The display server 100 receiving a team selection request from the user device 20 via the team planning/selection interface. The display server 100 then determines whether the user has joined the display team based on the records stored in the database.

The method of the present invention further includes wherein the display server 100 generates a display team leaderboard for each the display theme based on multiple display themes.

The formula for generating the social media popularity score is as follows:

The social media popularity=(social media interaction behavior)*(personalized behavior evaluation weight)*(current platform behavior weight).

A social media interaction behavior considered in this formula include liking, commenting, sharing, following, and browsing, as demonstrated in FIG. 7. A personalized behavior evaluation weight is evaluated by the user big data server 200 based on the behavior algorithm of the user account, to assess the weight of each social media interaction behavior.

A current platform behavior weight is evaluated by the user big data server 200 based on the behavior algorithm of the display theme, to assess the weight of each social media interaction behavior.

The method of the present invention further includes the display server 100 displays the social media popularity of the display team on the display interface of the display team.

The method of the present invention further includes the display server 100 displays the social media popularity of the display team on the display interface of the showpiece.

As described in one embodiment, the display server receives a team participation request from multiple user devices to join a display team via a team planning/selection interface. In response to the team participation request, the display server imports multiple digital content associated with the user accounts of the user devices. The imported digital content is designated as showpiece and information regarding their participation in the display team is stored in a database. The display server provides a display interface to showcase the showpiece and/or the display team in a specific display theme. The display interface also records social media interaction behavior data for each showpiece and/or the display team. Subsequently, the display server transmits the social media interaction behavior data to the user big data server. The user big data server receives the social media interaction behavior data and calculates the showpiece social media popularity for each showpiece, as well as the display team social media popularity for each display theme. These calculations are based on the quality differences observed in various social media interactions. The user big data server transmits the showpiece social media popularity and/or the display team social media popularity back to the display server. The display server stores the showpiece social media popularity and/or the display team social media popularity in the database.

The user device 20 includes a mobile phone, a computer, a tablet, and a handheld device.

The present invention enables the objective quantification of the social media popularity for digital content that a user showcases in the display, enabling the user to understand the popularity of their digital content and to identify which types of digital content are more popular.

### BRIEF DESCRIPTION OF THE DRAWINGS

FIG. 1 shows the schematic of a system block diagram of the method for method implemented by a display system for hosting digital content team display contests and quantifying social media popularity.

FIG. 2 shows the schematic of a process diagram of an embodiment of the invention for method implemented by a display system for hosting digital content team display contests and quantifying social media popularity.

FIG. 3 shows the schematic of a process diagram of another embodiment of the invention for method implemented by a display system for hosting digital content team display contests and quantifying social media popularity.

FIG. 4 shows the schematic of a showpiece in an embodiment of the present invention.

FIG. 5 shows the schematic of a showpiece editing interface in an embodiment of the present invention.

FIG. 6 shows the schematic of a showpiece leaderboard in an embodiment of the present invention.

FIG. 7 shows the schematic of a social media interaction behavior in an embodiment of the present invention.

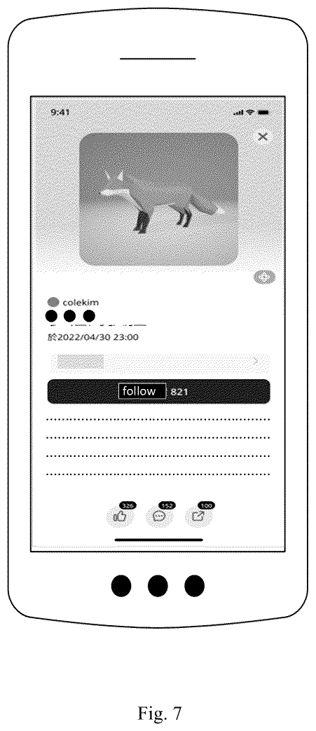

### DETAILED DESCRIPTION OF THE INVENTION

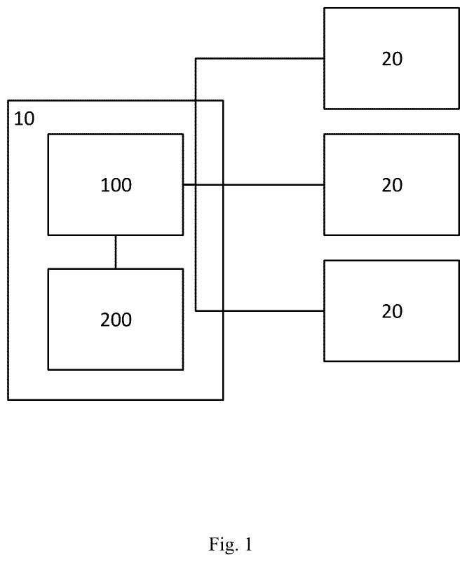

The present invention provides a method for a method implemented by a display system for hosting digital content team display contests and quantifying social media popularity, which is implemented by a display system 10 that is applicable to a user device 20 capable of logging into the display system 10 with a user account. Please refer to FIG. 1, which is a block diagram of a system according to an embodiment of the present invention. The display system 10 comprises a display server 100 and a user big data server 200, which can be set up in different locations. The user device 20 can connect to the display server 100 through the network, and the display server 100 and the user big data server 200 can be connected directly or through the network.

The ordinary skilled persons in the relevant field should possess common knowledge of computer architecture and organization and understand that the present invention does not restrict the form of these computers or the architecture of network connection. The display server 100 and the user big data server 200 can be made up of multiple computers if they offer corresponding functions. A computer comprises a processor, memory module connected to the processor, and server network interface. The processor is used to execute the operating system and application programs stored in memory, such as database management systems (DBMS), web servers, and/or web application servers, to carry out the various Steps mentioned in the present invention embodiment. The invention can be implemented through a website website, an application program (APP), or other means.

The display server 100 is responsible for providing and processing information related to the display, and may include or connect to a database that stores display data and related information. This information may include, but is not limited to, user data, a digital content, a showpiece data, a display team data, a social media interaction behavior data, and a social media popularity.

In addition to the components shown in FIG. 1, the display system 10 and the user device 20 can also be connected to various social media media websites, video websites, cryptocurrency websites, and non-fungible token (NFT) trading websites through the network, although they are not explicitly shown in the FIG. Through sharing or authorization mechanisms, users can import the digital content they share on these websites into the display system 10.

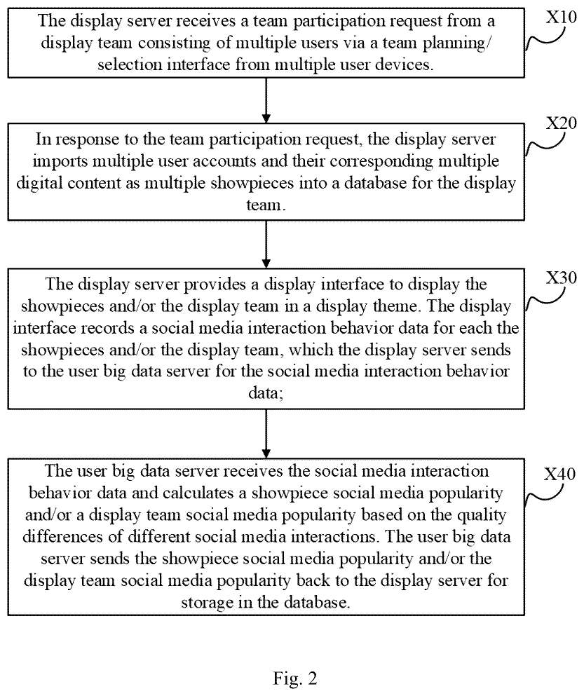

This invention presents a method for a method implemented by a display system for hosting digital content team display contests and quantifying social media popularity using a display system 10 as shown in FIGS. 1 and 2. The display system 10 comprises a display server 100 and a user big data server 200. The method involves the following Steps:
Step X10: The display server 100 receives a team participation request from a display team consisting of multiple users via a team planning/selection interface from multiple user devices 20.
Step X20: In response to the team participation request, the display server 100 imports multiple user accounts and their corresponding multiple digital content as multiple showpieces into a database for the display team.
Step X30: The display server 100 provides a display interface to display the showpiece and/or the display team in a display theme. The display interface records a social media interaction behavior data for each the showpiece and/or the display team, which the display server 100 sends to the user big data server 200 for the social media interaction behavior data; and
Step X40: The user big data server 200 receives the social media interaction behavior data and calculates a showpiece social media popularity and/or a display team social media popularity based on the quality differences of different social media interactions. The user big data server 200 sends the showpiece social media popularity and/or the display team social media popularity back to the display server 100 for storage in the database.

In addition to the previous Steps, the display server 100 also provides a team management interface, which includes a showpiece management interface. This interface allows a manager to adjust the showpiece of the display in the display team to participate in different the display theme during the display period. The manager can also adjust the showpiece participating in the display team according to the ranking of a showpiece leaderboard to obtain a higher ranking of the display team social media popularity in the leaderboard.

In the above scenario, the display server 100 receives a showpiece management request from a manager account. The display server 100 adjusts the showpiece in the display theme based on the showpiece management request, and sends a notification message to the user device 20 containing the showpiece.

The team management interface also includes an exchange management interface. The exchange management interface enables the manager to designate an exchange between the showpiece and/or the user account within the team and those in another team.

In the above scenario, the display server 100 receives an exchange request that is initiated by the manager account. Subsequently, the display server 100 sends a message to the user device 20 associated with the manager account in another team, in accordance with the exchange request. Furthermore, the display server 10 receives an agreement to the exchange request from the user device 20 that belongs to the manager account in the other team, and then proceeds to carry out the exchange of the showpiece and/or the user account as requested.

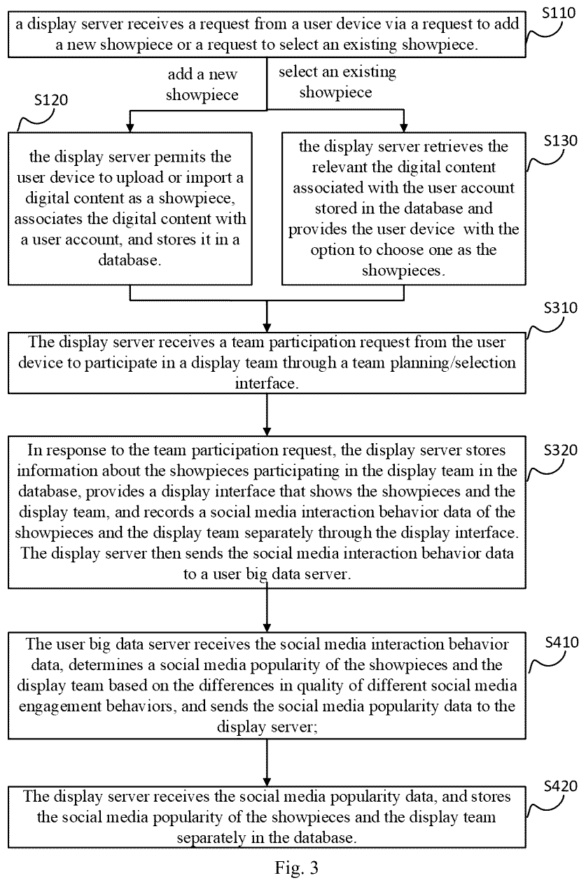

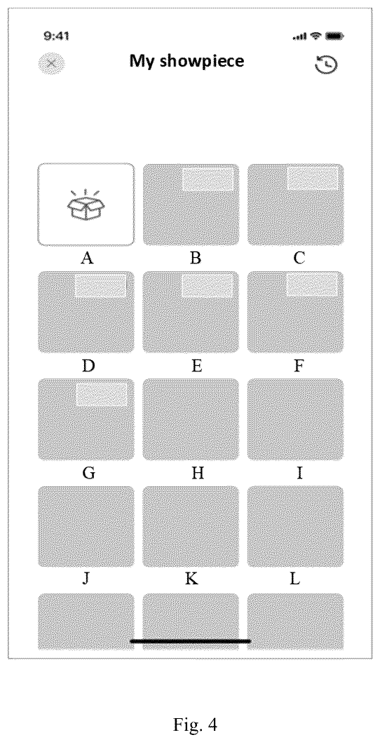

The following is a flowchart illustrating an additional embodiment of the invention in FIG. 3, which is a method implemented by a display system for hosting digital content team display contests and quantifying social media popularity. The method comprises the following Steps:
Step S110: a display server 100 receives a request from a user device 20 via a request to add a new showpiece or a request to select an existing showpiece.
Step S120: In case of the request to add a new showpiece, the display server 100 permits the user device 20 to upload or import a digital content as a showpiece, associates the digital content with a user account, and stores it in a database.
Step S130: If it is a request to select the request to select an existing showpiece. Please refer to FIG. 4, the display server 100 retrieves the relevant the digital content associated with the user account stored in the database and provides the user device 20 with the option to choose one as the showpiece.
Step S310: The display server 100 receives a team participation request from the user device 20 to participate in a display team through a team planning/selection interface.
Step S320: In response to the team participation request, the display server 100 stores information about the showpiece participating in the display team in the database, provides a display interface that shows the showpiece and the display team, and records a social media interaction behavior data of the showpiece and the display team separately through the display interface. The display server 100 then sends the social media interaction behavior data to a user big data server 200.
Step S410: The user big data server 200 receives the social media interaction behavior data, determines a social media popularity of the showpiece and the display team based on the differences in quality of different social media engagement behaviors, and sends the social media popularity data to the display server 100; and
Step S420: The display server 100 receives the social media popularity data, and stores the social media popularity of the showpiece and the display team separately in the database.

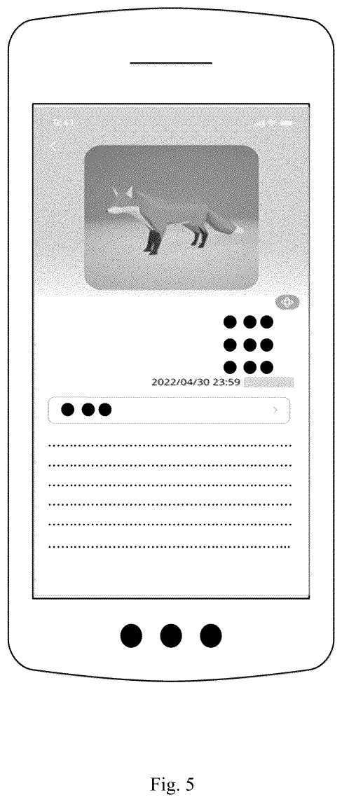

In FIG. 5, an additional Step is shown as part of the method of the present invention. Specifically, Step S140 involves the display server 100 providing a showpiece editing interface to the user device 20, which allows the user to input a showpiece description. The display server 100 then stores the showpiece description in the database, and displays it on the showpiece of the display interface.

As described in one embodiment, the social media popularity further includes a showpiece social media popularity, a user social media popularity, and a display team social media popularity.

In the method of the present invention, Step S211 involves the display server 100 receiving a team planning request from the user device 20 through the team planning/selection interface, and providing a team construction interface in response to the team planning request. Using the team construction interface, the display server 100 then receives a team information and a team publishing request from the user device 20, stores the team information in the database, and displays it on the display interface of the display team.

In the method of the present invention, Step S212 includes the display server 100 receiving a team selection request from the user device 20 via the team planning/selection interface. The display server 100 then determines whether the user has joined the display team based on the records stored in the database.

In addition, the method of the present invention includes Step S221 of the present invention involves the display server 100 receiving a request for a display theme from the user device 20 via a theme planning/selection interface. Upon receiving the request, the theme planning/selection interface is provided. The display server 100 then receives a display theme information and a publish display theme request. The display theme information is stored in the database, and the display theme is displayed on the display interface.

In addition, the method of the present invention includes Step S222: The display server 100 receives a request from the user device 20 to a select display theme request through the theme planning/selection interface.

In one embodiment, the method of the present invention further includes Step S510: The display server 100 displays the display team social media popularity of the display team on the display interface of the display team.

In one embodiment, the method of the present invention further includes Step S610: The display server 100 displays the showpiece social media popularity of the showpiece on the display interface of the showpiece.

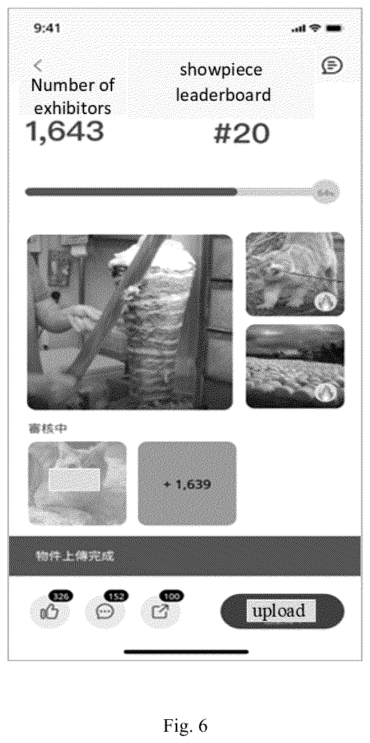

In one embodiment, the method of the present invention further includes Step S710: Wherein the display server 100 generates a social media popularity leaderboard for each the display theme based on multiple display themes. The social media popularity leaderboard includes a showpiece leaderboard, a user leaderboard, and a display team leaderboard, as shown in FIG. 6.

The display interface websites also encompass streaming websites (such as YouTube, TikTok, etc.) and social media media websites (such as Facebook, Line, etc.).

The formula for generating the showpiece social media popularity is generated according to the following calculation formula:

showpiece social media popularity=(counts of the social media interaction behavior)*(personalized behavior evaluation weight)*(current platform behavior weight);

wherein the social media interaction behavior includes: liking, commenting, sharing, following, and browsing;
the personalized behavior evaluation weight is assessed based on the historical behaviors of the user account by the user big data server;
the current platform behavior weight is assessed based on the statistical behaviors of the display theme by the user big data server.

The weights for each user behavior are calculated by the user big data server 200 based on the user's historical the social media interaction behavior records, or they can be manually set by the manager.

This invention presents a method for a method implemented by a display system 10 for hosting digital content team display contests and quantifying social media popularity, wherein the display system 10 comprises a display server 100 and a user big data server 200, the method comprising the steps of: receiving, by the display server 100, a team participation request from multiple user devices 20 for joining a display team, the team participation request being transmitted via a team planning/selection interface; in response to the team participation request, importing by the display server 100, multiple digital content associated with the multiple user accounts of the user devices 20, designating the digital contents as multiple showpieces, and storing information pertaining to the showpieces' participation in the display team in a database; providing, by the display server 100, a display interface to present the showpiece and/or the display team within a display theme, wherein the display interface records social media interaction behavior data for each showpiece and/or the display team; transmitting, by the display server 100, the social media interaction behavior data to the user big data server 200; receiving, by the user big data server 200, the social media interaction behavior data, calculating a showpiece social media popularity for each showpiece and/or a display team social media popularity for each display team based on the quality differences among different social media interactions; transmitting, by the user big data server 200, the showpiece social media popularity and/or the display team social media popularity back to the display server 100; and storing, by the display server 100, the showpiece social media popularity and/or the display team social media popularity in the database.

For instance, the user big data server 200 employs AI algorithms to evaluate the weight of the social media interaction behavior based on actions such as liking, commenting, sharing, following, and browsing, but is not limited to these.

| | social media interaction behavior | | | | |
|---|---|---|---|---|---|
| | browsing | liking | sharing | commenting | following |
| weight score | 1 | 4 | 6 | 8 | 10 |

For instance, the personalized behavior evaluation weight is calculated by the user big data server 200 using AI algorithms to assess the weight of all the social media interaction behavior that have taken place on the user account. The weight score is determined by considering the frequency and ease of social media interaction behaviors that have occurred on the user account, but not limited to this.

| | user account | | | | |
|---|---|---|---|---|---|
| | A1 | A2 | A3 | A4 | A5 |
| Classification | No | easily | common | careful | major |
| | reference | | | | |
| | value | | | | |
| weight score | 0 | 1 | 2 | 3 | 4 |

For instance, the current platform behavior weight is evaluated by the user big data server 200 using AI algorithms to assess the popularity and/or audience characteristics of the display theme, among other factors.

| | display theme | | |
|---|---|---|---|
| | B1 | B2 | B3 |
| Classification | Unpopular | common | popular |
| weight score | 1 | 2 | 3 |

In one embodiment, for example, the social media interaction behavior data of a certain user's displayed showpiece E1 is as follows.

social media interaction behavior data of showpiece El (times)

| display | | | | | |
|---|---|---|---|---|---|
| theme | browsing | liking | sharing | commenting | following |
| B1 | 2000 | 200 | 20 | 10 | 5 |
| B2 | 1500 | 150 | 15 | 2 | 1 |

The social media interaction behavior: liking, commenting, sharing, following, and browsing;

showpiece social media popularity=(browsing*weight+liking*weight+sharing*weight+commenting*weight+following*weight)*current platform behavior weight;

The showpiece social media popularity of showpiece E1 in B1 theme=(2000*1+200*4+20*6+10*8+5*10)*1=3050;

The showpiece social media popularity of showpiece E1 in B2 theme=(1500*1+150*4+15*6+2*8+1*10)*2=4432;

The total showpiece social media popularity of showpiece E1=3050+4432=7482.

The social media interaction behavior data mentioned above can be further calculated based on the personalized behavior evaluation weight of the interacting users. For example, in the above embodiment, if the 5 following numbers of theme B1 are contributed by users A1, A2, A3, A4, and A5 respectively, then the social media popularity of B1 is calculated as follows.

The showpiece social media popularity of B1=(2000*1+200*4+20*6+10*8+(0+1+2+3+4)*10)*1=3100.

In one embodiment, the commenting of the social media interaction behavior data, is given different weight score after being analyzed by natural language processing.

| | commenting | | | | |
|---|---|---|---|---|---|
| | negative | negative | | positive | |
| | 2 | 1 | irrelevant | 1 | positive 2 |
| weight score | −10 | −5 | 1 | +5 | 10 |

In the above implementation example, if there are 2 commenting for theme B2 in the social media interaction behavior data, with 1 negative 1 and 1 positive 2, the showpiece social media popularity for the B2 would be.

The showpiece social media popularity of B2=(1500*1+150*4+15*6+(−5+10)*8+1*10)*2=4480.

In one embodiment, the display team social media popularity of the display team is as follows.

| | | | | social media |
|---|---|---|---|---|
| showpiece | user account | display team | display theme | popularity |
| E1 | A1 | C1 | B1 | 1050 |
| E1 | A1 | C1 | B2 | 1010 |
| E2 | A1 | C1 | B1 | 2100 |
| E3 | A2 | C1 | B1 | 2000 |
| E3 | A2 | C1 | B2 | 1500 |
| E4 | A2 | C2 | B3 | 1200 |
| E5 | A3 | C2 | B1 | 2500 |
| E6 | A3 | C2 | B1 | 3110 |
| E7 | A3 | C2 | B1 | 3300 |
| E8 | A4 | C2 | B1 | 2450 |

In A1 user account, there are two the showpiece of E1 and E2. The showpiece E1 is displayed in the display themes of B1 and B2, while the showpiece E2 is displayed in the display themes of B 1. The showpiece social media popularity calculated based on the social media interaction behavior is 1050, 1010, and 2100, all belonging to the display team of C1;
In A2 user account, there are two the showpiece of E3 and E4. The showpiece E3 is displayed in the display themes of B1 and B2. Later, the user account of A2 moved to the display team of C2, while the showpiece E4 is displayed in the display themes of B3. The showpiece social media popularity calculated based on the social media interaction behavior is 2000 and 1500, all belonging to the display team of C1 , and 1200 belongs to the C2 display team;
In A3 user account has three d the showpiece of E5, E6, and E7, all displayed in the display themes of B1. The showpiece social media popularity calculated based on the social media interaction behavior is 2500, 3110 and 3300, all belonging to the display team of C2;
In A4 user account has one showpiece of E8 displayed in the display themes B1. The showpiece social media popularity calculated based on the social media interaction behavior is 2450, all belonging to the display team of C2;
The display team social media popularity of the C1 display team in the B1 display themes is: 1050+2100+2000=5150;
The display team social media popularity of the C1 display team in the B2 display themes is: 1010+1500=2510;
The total display team social media popularity of the C1 display team is: 5150+2510=7660;
The display team social media popularity of the C2 display team in the B1 display themes is: 2500+3110+3300+2450=11360;
The display team social media popularity of the C2 display team in the B3 display themes is: 1200;
The total display team social media popularity of the C2 display team is: 11360+1200=12560.

The showpiece leaderboard in the social media popularity leaderboard is as follows.

| | | user | display | display | showpiece social |
|---|---|---|---|---|---|
| ranking | showpiece | account | team | theme | media popularity |
| 1 | E7 | A3 | C2 | B1 | 3300 |
| 2 | E6 | A3 | C2 | B1 | 3110 |
| 3 | E5 | A3 | C2 | B1 | 2500 |
| 4 | E8 | A4 | C2 | B1 | 2450 |
| 5 | E2 | A1 | C1 | B1 | 2100 |
| 6 | E3 | A2 | C1 | B1 | 2000 |
| 7 | E3 | A2 | C1 | B2 | 1500 |
| 8 | E4 | A2 | C2 | B3 | 1200 |
| 9 | E1 | A1 | C1 | B1 | 1050 |
| 10 | E1 | A1 | C1 | B2 | 1010 |

The user leaderboard in the social media popularity leaderboard is as follows.

| | | | | | show- | user |
|---|---|---|---|---|---|---|
| | | | | | piece | social |
| | | | | | social | media |
| | | | dis- | dis- | media | popu- |
| rank- | user | show- | play | play | popu- | larity |
| ing | account | piece | team | theme | larity | total |
| 1 | A3 | E7 | C2 | B1 | 3300 | 8910 |
| | | E6 | C2 | B1 | 3110 | |
| | | E5 | C2 | B1 | 2500 | |
| 2 | A2 | E4 | C2 | B3 | 1200 | 4700 |
| | | E3 | C1 | B1 | 2000 | |
| | | E3 | C1 | B2 | 1500 | |
| 3 | A1 | E2 | C1 | B1 | 2100 | 4160 |
| | | E1 | C1 | B1 | 1050 | |
| | | E1 | C1 | B2 | 1010 | |
| 4 | A4 | E8 | C2 | B1 | 2450 | 2450 |

The display team social media popularity in the social media popularity leaderboard is as follows.

| | | | | | | display |
|---|---|---|---|---|---|---|
| | | | | | show- | team |
| | | | | | piece | social |
| | | | | | social | media |
| | | | | dis- | media | popu- |
| rank- | display | user | show- | play | popu- | larity |
| ing | team | account | piece | theme | larity | total |
| 1 | C2 | A3 | E7 | B1 | 3300 | 12560 |
| | | A3 | E6 | B1 | 3110 | |
| | | A3 | E5 | B1 | 2500 | |
| | | A2 | E4 | B3 | 1200 | |
| | | A4 | E8 | B1 | 2450 | |
| 2 | C1 | A2 | E3 | B1 | 2000 | 7660 |
| | | A2 | E3 | B2 | 1500 | |
| | | A1 | E2 | B1 | 2100 | |
| | | A1 | E1 | B1 | 1050 | |
| | | A1 | E1 | B2 | 1010 | |

In one embodiment, the showpiece leaderboard, the user leaderboard, and the display team leaderboard for the showpiece can be converted into a level experience value and accumulated.

In one embodiment of the present invention, the entire system is implemented through an application (APP). A user operates the user device 20 to open the application, and the application displays an operation page. On the operation page, the user can select to add the showpiece or choose an existing the showpiece to participate in the showpiece. If the user chooses an existing the showpiece, a list of the digital content previously stored in the database is displayed for the user to select one as the showpiece. If the user chooses to add a new the showpiece, the operation page provides source options for the user to select and/or fill in. These source options include uploading from the user device 20, importing from a URL, and importing from an encrypted cryptocurrency wallet. The URL may be a link to the digital content shared by the user on social media media websites, video websites, cryptocurrency websites, and NFT trading websites, while the encrypted cryptocurrency wallet may be a wallet that stores purchased NFT's, such as the Metamask wallet. Importing from an encrypted cryptocurrency wallet requires a third-party authorization process, which is common knowledge in the art and not the focus of the present invention, and thus not described in detail.

If the user chooses to upload from the user device 20, the digital content can be selected from the user device 20 of photo album and/or folder. If the user chooses to import a URL, the operating page further prompts the user to enter the link URL of the digital content, and then the application will parse whether the link is correct. If it is incorrect, the user will be asked to re-enter the URL. If the user chooses to import from an encrypted cryptocurrency wallet, the application will link to the third-party authorization unit to authorize the user to enter the encrypted cryptocurrency wallet and select the digital content. The uploaded or imported the digital content will be associated with the user account and stored in the database.

When a user uploads or imports the digital content as the showpiece, the application can open the showpiece editing interface for the user to edit and provide descriptions for the showpiece. Alternatively, the user can skip this step and proceed to the team planning/selection interface, join the display team, and submit the team participation request. When the application receives the team participation request, information about the user's display and the associated display team will be stored in the database, and the application will open the display interface to display the showpiece and display team.

In the team planning/selection interface, users have the option to either create a new the display team or select an existing one. If they choose to create a new the display team, the application will open the team construction interface for them to input and publish the team information, followed by submitting the team participation request. Alternatively, users can browse the information of published the team information on the team planning/selection interface and select one of interest. The application will then check the database to see if the user has already joined the selected the display team. If they have, the participation requirements will be displayed, and the user will be asked to confirm whether to submit the team participation request. If they have not joined the display team yet, the participation requirements will still be shown, and the user will be asked to confirm if they agree to join and submit the team participation request.

In the display interface, both the user's showpiece and other users' showpiece within the same display team will be displayed. The application offers various social media interaction behavior options to all users, such as liking, commenting, sharing, following, and browsing. The application also keeps a record of the social media interaction behavior data for the showpiece and display team, and determines the social media popularity of the showpiece and display team based on the quality differences among various the social media interaction behavior. The application manager may choose to display the social media popularity of the showpiece and display team in the display interface, depending on the app design.

Within the application, the display team can be categorized into a specific the display theme based on the type of their showpiece. The social media popularity of all the display team within each the display theme is calculated and ranked, resulting in the display team leaderboard for each the display theme. This competition aspect creates team battles that stimulate users to publish better the digital content for display. Furthermore, the social media popularity of the display team can be converted into experience points, which accumulate over time and allow users to level up and receive rewards. This approach also motivates users to publish higher-quality the digital content for display.

1. A method implemented by a display system for hosting digital content team display contests and quantifying social media popularity, wherein the display system comprises a display server and a user big data server, the method comprising the steps of:
receiving, by the display server, a team participation request from multiple user devices for joining a display team, the team participation request being transmitted via a team planning/selection interface;
in response to the team participation request, importing by the display server, multiple digital content associated with the multiple user accounts of the user devices, designating the digital contents as multiple showpieces, and storing information pertaining to the showpieces' participation in the display team in a database;
providing, by the display server, a display interface to present the showpiece and/or the display team within a display theme, wherein the display interface records a social media interaction behavior data for each showpiece and/or the display team;
transmitting, by the display server, the social media interaction behavior data to the user big data server;
receiving, by the user big data server, the social media interaction behavior data, calculating a showpiece social media popularity for each showpiece and/or a display team social media popularity for each display theme based on the quality differences among different social media interactions;
transmitting, by the user big data server, the showpiece social media popularity and/or the display team social media popularity back to the display server; and
storing, by the display server, the showpiece social media popularity and/or the display team social media popularity in the database.

2. The method of claim 1, further comprising: calculating, by the user big data server, a showpiece leaderboard, a user leaderboard, and a display team leaderboard based on the display theme.

3. The method of claim 1, further comprising: providing, by the display server, a showpiece management interface to receive a showpiece management request issued by a manager account, and adjusting the showpiece participating within the display theme based on the showpiece management request.

4. The method of claim 1, further comprising: providing, by the display server, an exchange management interface to receive an exchange request issued by a manager account, sending a notification message to the user device associated with the manager account of another display team based on the exchange request, receiving an agreement to the exchange request from the user device associated with the manager account of another display team, and executing the exchange of the showpiece and/or the user account.

5. The method of claim 1, wherein the showpiece are displayed by the display server from the user device via a request to add a new showpiece or a request to select an existing showpiece; if the request is to add a new showpiece, the display server allows the user device to upload or import the digital content as the showpiece, associates the digital content with the user account, and stores it in the database; if the request is to select an existing showpiece, the display server retrieves the digital contents associated with the user account form the database and offers the user device an option to select one of the digital contents as the showpiece.

6. The method of claim 5, wherein the method of importing the digital content includes importing from URLs of various digital content platforms and importing from encrypted cryptocurrency wallets.

7. The method of claim 1, further comprising: receiving, by the display server, a team planning request from the user device via the team planning/selection interface, in response to the team planning request, providing a team construction interface; receiving team information and a team publishing request via the team construction interface, storing the team information in the database, and presenting the team information on the display interface of the display team.

8. The method of claim 1, further comprising: receiving, by the display server, a team selection request from the user device via the team planning/selection interface and, in response to the team selection request, determining, based on the records stored in the database, whether the user account has joined the display team.

9. The method of claim 1, further comprising: providing, by the display server, a theme planning/selection interface, wherein the display theme entered by the user device is received via the theme planning/selection interface.

10. The method of claim 1, wherein the showpiece social media popularity is generated according to the following calculation formula:
showpiece social media popularity=(counts of the social media interaction behavior)*(personalized behavior evaluation weight)*(current platform behavior weight);
wherein the social media interaction behavior includes: liking, commenting, sharing, following, and browsing;
the personalized behavior evaluation weight is assessed based on the historical behaviors of the user account by the user big data server;
the current platform behavior weight is assessed based on the statistical behaviors of the display theme by the user big data server.
